(19) United States
(12) Patent Application Publication
(10) Pub. No.: US 2024/0316492 A1
(43) Pub. Date: Sep. 26, 2024

(54) METHODS AND APPARATUS FOR GAS SEPARATION MEMBRANE

(71) Applicant: University of Notre Dame du Lac, South Bend, IN (US)

(72) Inventors: Jiaxin Xu, South Bend, IN (US); Ruilan Guo, South Bend, IN (US); Meng Jiang, South Bend, IN (US); Tengfei Luo, South Bend, IN (US); Agboola Suleiman, South Bend, IN (US); Gang Liu, South Bend, IN (US)

(21) Appl. No.: 18/611,015

(22) Filed: Mar. 20, 2024

Related U.S. Application Data
(60) Provisional application No. 63/491,405, filed on Mar. 21, 2023.

(51) Int. Cl. B01D 53/22; B01D 71/64; C08G 73/10

(52) U.S. Cl. CPC B01D 53/228; B01D 71/64; C08G 73/1067; C08G 73/1082; B01D 2257/504

(57) ABSTRACT

A membrane for use in gas separation may contain a polymer having at least one of either polyimide poly[(naphthalene-1,5-diamine)-alt-(biphenyl-3,3′:4,4′-tetracarboxylic dianhydride)] or poly[isophoronediamine-alt-(biphenyl-3,3′,4,4′-tetracarboxylic anhydride)]. These polyimides were predicted to exhibit above-threshold performance for separating multiple gas pairs for use in industrial applications, such as air separation (O₂/N₂) and hydrogen separations (H₂/CH₄, H₂/N₂), based on a novel graph neural network machine learning model. Performance may be predicted by analyzing polymer properties and structure and comparing against labeled or known performance data for other known polymers. The performance of the polymers for use in gas membranes may then be experimentally verified.

### REFERENCE TO RELATED APPLICATION

This application claims priority from provisional application No. 63/491,405 filed on Mar. 21, 2023, and incorporated herein by reference in its entirety.

### GOVERNMENT LICENSE RIGHTS

This invention was made with government support under grant CBET2102592 awarded by the National Science Foundation. The government has certain rights in the invention.

### TECHNICAL FIELD

This disclosure generally relates to using polymer membranes to reduce the energy, carbon, and water intensity of traditional thermally driven separation and, more particularly to methods and materials for a gas separation membrane.

### BACKGROUND

The creation of novel membrane materials with tailored properties may be a key to providing low-energy solutions to many of the separation-related challenges facing humanity in environment, energy, and sustainability. Membrane-based separation technologies promise to dramatically drive down the energy-, carbon- and water-intensity of traditional thermally driven separation processes. Known gas separation systems and processes may include using a membrane to facilitate a thermal separation process. Separation processes, mainly carried out by inefficient thermal processes, account for 10-15% of current global energy consumption.

Materials-driven, membrane-based separation technologies promise to dramatically drive down the energy, carbon and water intensity of traditional thermally driven separation processes. The creation of novel membrane materials with tailorable yet predictable structures and properties are believed to be important to providing low-energy solutions to some of the world's most challenging and vital separations. However, the development cycles of such materials are usually exceptionally long due to the trial-and-error strategy traditionally used. A graph augmented and imbalanced machine learning technique may be utilized to assist in the identification and design of polymers with exceptional performance separating multiple industrially critical gas pairs. A resulting membrane created from two polymers identified by the machine learning technique may more efficiently separate industrially critical gas pairs.

### BRIEF DESCRIPTION OF THE DRAWINGS

FIG. 1 is a diagram representation of the formula for the polyimide poly[(naphthalene-1,5-diamine)-alt-(biphenyl-3,3′:4,4′-tetracarboxylic dianhydride)].

FIG. 2 is a diagram representation of the formula for the polyimide poly[isophoronediamine-alt-(biphenyl-3,3′,4,4′-tetracarboxylic anhydride)].

FIGS. 3A-3D are graphical representations of a machine learning model framework and experimental and computational validation process.

FIG. 3E is a simplified flowchart of the graphical representations of FIGS. 3A-3D.

FIG. 4A-E are Robeson plot visualizations predicted by machine learning for five different separation tasks: (a) O₂/N₂, (b) H₂/CH₄, (c) H₂/N₂, (d) CO₂/CH₄, and (e) CO₂/N₂.

FIG. 5 are Robeson plots showing the experimental results and ML predictions.

### DETAILED DESCRIPTION

Computing based machine learning (“ML”) models help scan large databases of chemical compositions, or polymers, to efficiently identify promising candidates for the separation of different gas pairs (such as O₂/N₂, H₂/CH₄, H₂/N₂, CO₂/CH₄, CO₂/CH₄, and CO₂/N₂). Hierarchical fingerprint and trained Gaussian Process Regression (GPR) models based on a database of known polymer performance in gas separation for major industrial gases may be used. However, as the GPR models were time-intensive, only a small number (around 315) of polymers were used, and the resulting training data contained very few points above an “upper bound” of polymer gas separation performance (the “small data” problem). Therefore, GPR predictions for unknown polymer performances were hardly above such upper bounds either (the “imbalanced data” problem).

Daylight-like fingerprint and trained GPR models based on the experimental data of six gases with around 400-700 data points (of polymer performance) for each gas may further be used. Using the daylight-like fingerprint and trained GPR models, a larger database may be screened. In previous experimentation, two polymers were identified from this method and successfully synthesized. However, the fingerprinting method used to represent polymers made the prediction result unexplainable, and the identified two polymers were only targeted for one separation task (CO₂/CH₄) (the “model interpretability” problem).

Molecular dynamics (MD) simulations and supervised ML may be combined to identify promising polymer candidates and may be able to explain prediction using SHAP (Shapley additive explanations). Using ML to design polymers with performance above the gas separation upper bounds remains difficult due to the overall limited data availability (small data), extreme data scarcity above the upper bound (imbalanced data), difficulty in explaining the results (model interpretability), and the need of experimental validation.

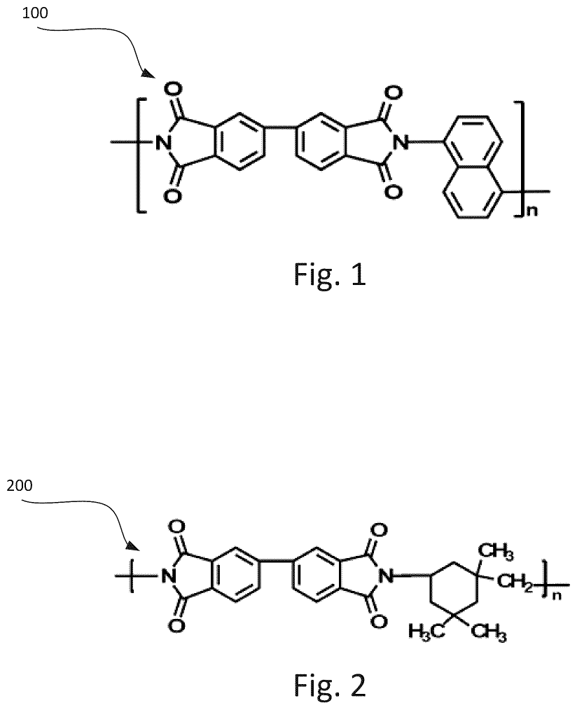

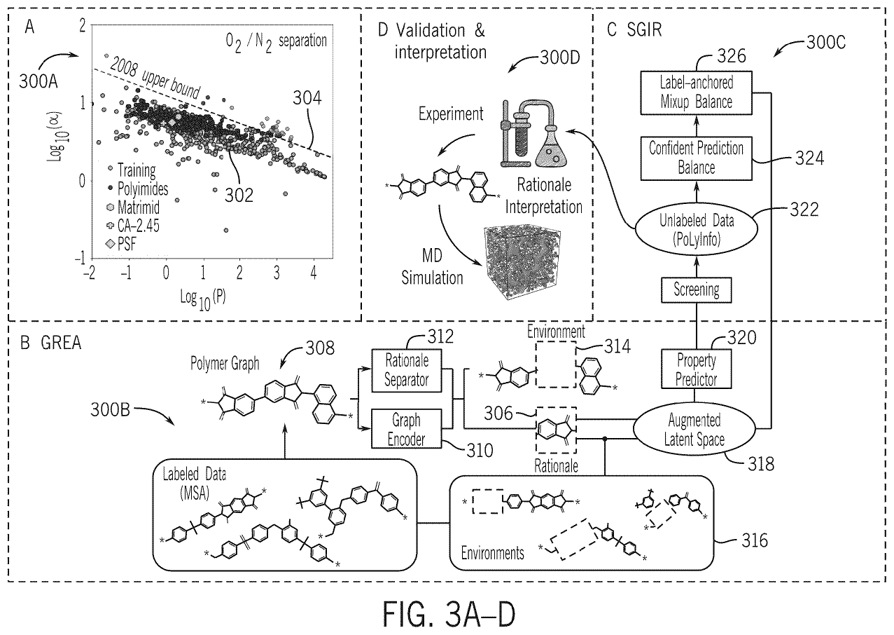

Referring to the drawings, wherein like reference numerals refer to the same or similar features in various views, FIG. 1 shows an example polymer, poly[(naphthalene-1,5-diamine)-alt-(biphenyl-3,3′:4,4′-tetracarboxylic dianhydride)] 100 and FIG. 2 shows another example polymer, poly[isophoronediamine-alt-(biphenyl-3,3′,4,4′-tetracarboxylic anhydride)] 200 both for use as membrane materials for the separation of different gas pairs, such as O₂/N₂, H₂/CH₄, H₂/N₂. In particular, separation applications, such as the O₂/N₂ separation (i.e., air separation), are difficult due to the similarity in molecular sizes of O₂ and N₂. The performance of polymers in gas separation applications may be predicted according to a novel machine learning process. Performance may be validated through the synthesis of the polymers and experimentation. The polymers were synthesized for use as gas separation membranes according to the methods and systems described herein.

### Predicting Polymer Performance

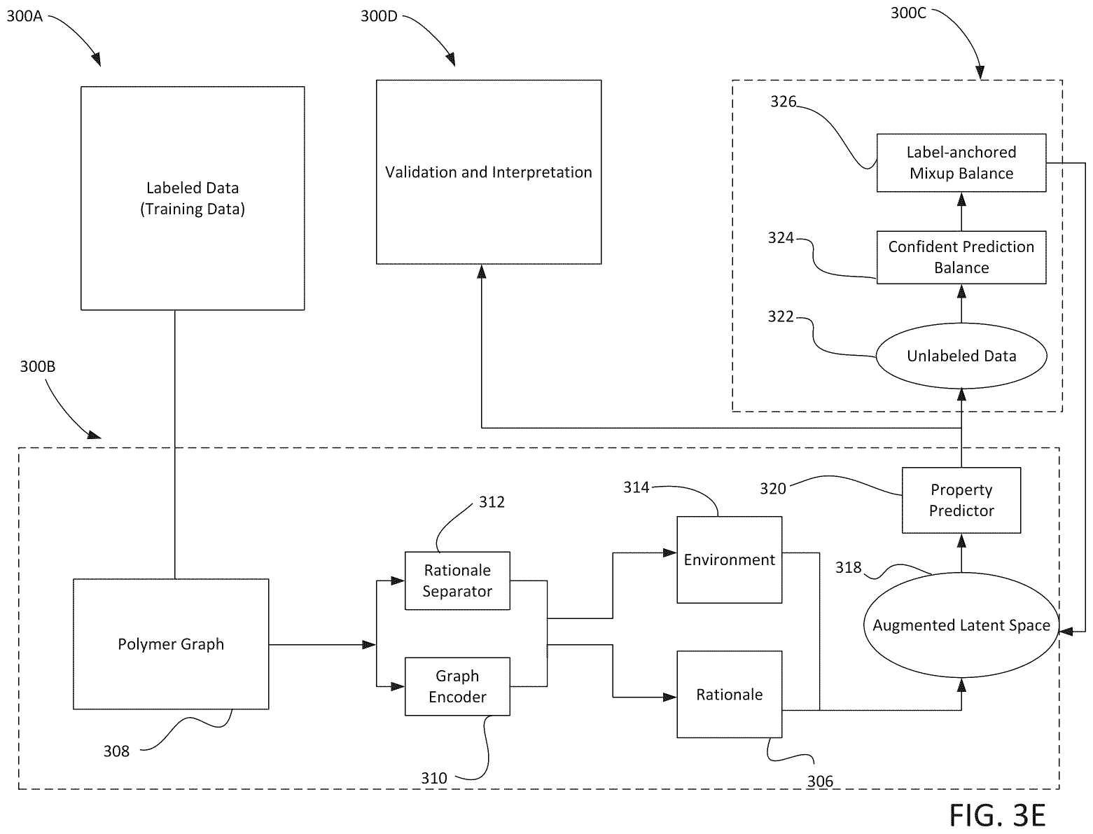

FIGS. 3A-D illustrate a novel explainable data-augmentation graph neural network (“GNN”) for imbalanced regression, which may be developed using a method combining graph rationalization enhanced by environment-based augmentation (the “GREA” method, as shown in FIG. 3B) and semi-supervised learning for imbalanced regression (the “SIGR” method, as shown in FIG. 3C). FIG. 3E illustrates a simplified flowchart of the graphical representations of FIGS. 3A-3D. Initial training data is in the form of a Robeson plot, as shown in FIG. 3A. A process of experimental and computational validation is shown in FIG. 3D.

Shown in FIG. 3A, a labeled (known or “training”) dataset 302 of polymer performance in gas separation applications is plotted in a Robeson plot 300A, with the lighter circles 302 representing the known data labels (each representing a performance point of one polymer). The labeled data (lighter circles) 302 are limited (500-800 per gas) and highly imbalanced, meaning the concentration of labeled, known data appear beneath the upper bound line 304.

Shown in FIG. 3B, the GREA method 300B can highlight essential features (rationale) 306 in a polymer graph representation 308 using the training data 302 from the Robeson plot 300A during training so that small data (training data) can effectively train the model while minimizing overfitting and improving generalizability. The polymer graph 308 is encoded by a graph encoder module 310 and divided into two parts by a rationale separator 312, first a rationale subgraph 306, provides support and interpretations for the decision-making process of GNNs, and an environment subgraph 314, which is considered as noise. The noise or environments 316 are combined with different rationale subgraphs 306 to create more polymers in a latent representation space 318. From the latent space 318, the GREA method may then take whole polymer structures built from rationale subgraphs 306 and environment components 316 and predict the property 320 of a whole polymer based on the resulting structure of the rationale combined with the environment.

Shown in FIG. 3C, because the labeled data are limited (500-800 per gas) and highly imbalanced, a semi-supervised framework for graph imbalanced regression (“SGIR”) 300C is used to leverage the much larger unlabeled data. The SGIR model performs a regression analysis. The SIGR may first assess the theoretical polymer performance of data points from the property predictor 320 in relation to the property values from known polymers but with unknown gas separation performance 322, in order to balance latent space 318 in a “Confident Prediction Balance” 324 manner, where highly confident predictions are selected. The SIGR then may use the “Label-anchored Mixup Balance” method 326, which mixes up a virtual data point and real labeled data in latent space to further balance the augmented latent space 318. In the “Label-anchored Mixup Balance,” a virtual data point is anchored at a certain label value that is still underrepresented in the expanded labeled dataset after “Confident Prediction Balance” 324. By anchoring or fixing some virtual or predicted data points at certain known or labeled data, the latent space 318 may still be grounded by actual, real-world values. In this manner, the SGIR model helps to refine the prediction results from the GREA model.

Using the above established models, the large database of polymers 322 which may be effective in use for gas separation may be scanned. Rationale is then used to interpret the GREA model prediction to identify the operative structure in the polymer which may be indicative of polymer performance in gas separation.

Shown in FIG. 3D, polymers may then be synthesized and tested experimentally. The ML predictions were found to be 80% accurate in terms of whether performance is above the upper bound. To understand the origin of the performance difference between polymers such as the ones shown in FIGS. 1-2, experimental measurements may be carried out to characterize the gas transport properties, MD simulations may be performed to investigate the free volume pore size distribution, and following the heuristic of GREA rationalization, backbone rigidities are analyzed using the semi-empirical atomistic model. A unique ML technique such as the one described above may be utilized to tackle small and imbalanced data problems, which are frequently encountered in materials development missions, and the resulting polymers may be used for high-performance membranes to separate several industrially critical gas pairs.

### Selection of Promising Polymer Candidates

Trained ML models for different target gases are then applied to a database repository of known polymers to predict their gas transport permeabilities. The prediction on the large database repository represents a large amount of new polymer gas transport data, which have never been experimentally tested before, providing useful guidance on the design of high-performance polymer membranes.

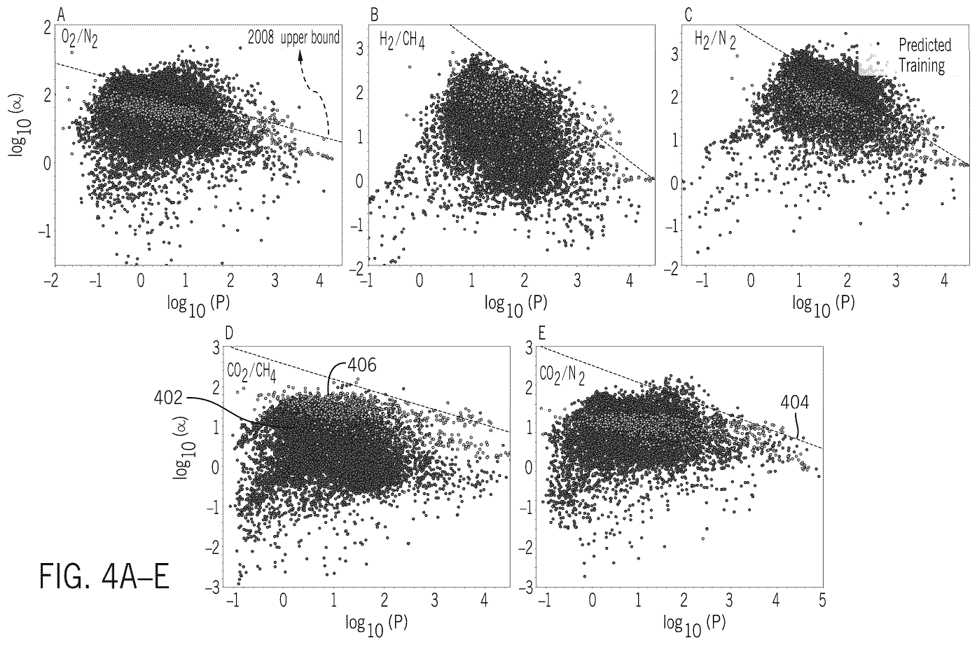

FIG. 4 shows the result of gas permeability-selectivity predicted on polymers in the large database repository (shown in darker circles) 402 for the five gas separation tasks, O₂/N₂, H₂/CH₄, H₂/N₂, CO₂/CH₄, CO₂/CH₄, and CO₂/N₂, plotted in the format of the Robeson plot, where the x-axis log₁₀P is the predicted permeability (P) in the unit of log₁₀Barrer, and the y-axis is the calculated selectivity a calculated from the ratios of the permeabilities of the gas pairs on the log₁₀ scale. For the screened polymers, the medians from the ensemble of ten independent models are reported. Most of the predicted permeability-selectivity values still lie below the upper bounds 404 for all the studied gas pairs, which is consistent with the training data (lighter circles) 406. However, the predicted areas (darker circles) 402 also extend beyond the training areas (lighter circles) 406, suggesting that GREA can have certain extrapolatable capability.

Shown in FIGS. 1-2, based on the screening results, two high-performance candidates for experimental validation were selected as a result of the above-described process and systems. The two polymers are poly[(naphthalene-1,5-diamine)-alt-(biphenyl-3,3′:4,4′-tetracarboxylic dianhydride)] (PoLyInfo ID: P130093) and poly[isophoronediamine-alt-(biphenyl-3,3′,4,4′-tetracarboxylic anhydride)] (PoLyInfo ID: P432352).

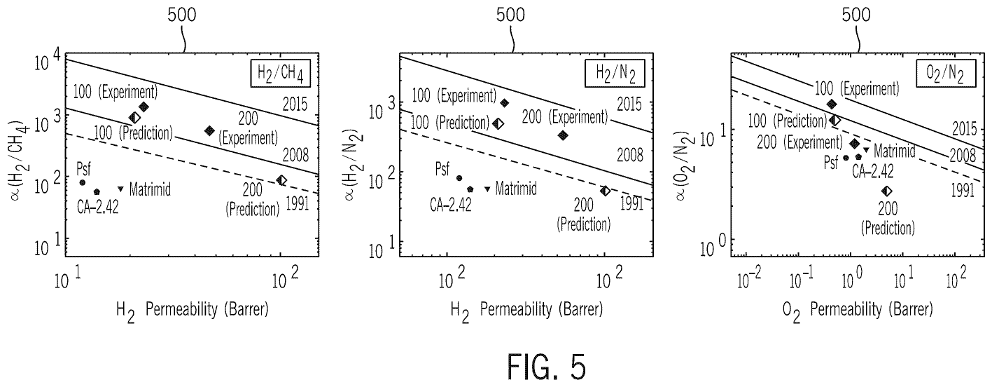

Shown in FIG. 5, these two candidates were chosen because their performances are predicted to simultaneously out-perform the upper bounds for multiple gas pairs, such as O₂/N₂, H₂/CH₄, and H₂/N₂, as shown in graphical format 500. It should be noted that O₂/N₂ separation is historically highly challenging using size-sieving types of membranes due to the similarity in O₂/N₂ molecular sizes.

Equally important, the two polymers are aromatic polyimides that may be prepared via conventional polycondensation reactions between commercially available aromatic dianhydrides and diamine monomers. This provides adequate confidence in their synthesizability. Their permeabilities for the five different gases may be measured, and the selectivity for the five gas pairs may be calculated.

### Synthesis and Film Casting of Polymer P130093

Polymer P130093 (43) was synthesized by dissolving 0.8030 g (5.076 mmol) of 1,5-diaminonaphthalene in 4 ml anhydrous NMP (N-Methyl-2-pyrrolidone) at 80° C. This was followed by the addition of an equimolar amount of 3,3′,4,4′-biphenyltetracarboxylic dianhydride and 11 ml anhydrous NMP to maintain 15 wt. % solid content while the temperature was maintained until complete dissolution of both monomers. Then, the reaction continued at room temperature for another 4 hours to obtain a viscous polyamic acid (PAA) solution. To complete the imidization and obtain thin films of the final polyimide, the PAA solution was diluted to 7.5% concentration with anhydrous NMP, filtered with 0.45 μm Teflon filters, and cast on glass plates under an infrared lamp at ˜ 60° C. for 24 h. It was then dried at 150° C. under vacuum for 12 hours, soaked in methanol for 3 hours, and dried again at 150° C. under vacuum for 12 hours. The solvent-free PAA film was sandwiched between two porous ceramic plates and thermally imidized in a muffle furnace under nitrogen flow, where the temperature was ramped at 10° C. per minute to 180, 210, 250, 350, and 400° C., maintaining 15 minutes at each temperature before finally cooling to room temperature at no greater than 10° C. per minute. The fully imidized structure of the solvent-free films was confirmed by proton nuclear magnetic resonance spectroscopy (¹H NMR), and Fourier transform infrared spectroscopy in attenuated total reflectance mode (ATR-FTIR).

### Synthesis and Film Casting of Polymer P432352

Polymer P432352 (44) was synthesized by reacting 1.7 g (9.98 mmol) of 5-amino-1,3,3-trimethyl cyclohexane methylamine with a stoichiometric amount of 3,3′,4,4′-biphenyltetracarboxylic dianhydride in 42 ml m-cresol at 11.2 wt. % concentration in a flame-dried 3-neck flask fitted with a mechanical stirrer. The monomers were fully dissolved within 1 hour at 70° C. and then maintained at 90° C. for 3 hours. Then, the temperature was gradually raised to 200° C. within 2 hours before 10 ml ortho-dichlorobenzene was added, and a Dean-Stark trap was attached for azeotropic reflux to complete the imidization over another 4 hours at 200° C. Fiber chunks of the product were obtained by precipitating the viscous solution into 600 ml stirring methanol, which was collected via filtration and dried at 100° C. for 12 hours in vacuo. The thin film of the polymer was obtained by solution casting on a circular glass plate using chloroform as the casting solvent. 1.6% w/v of the polymer solution was cast at room temperature under nitrogen flow for 48-72 hours, enabling slow evaporation of the solvent.

### Gas Permeation Tests

The pure permeabilities of the polymers for H₂, CH₄, N₂, O₂, and CO₂ were measured at 35° C. using a constant-volume variable-pressure method (45). Thin films (44-60 μm in thickness) of the polymers were mounted on aluminum duct tape with the aid of epoxy glue and protected on the backside with filter paper. The exposed film region was scanned with ImageJ to measure the available area for gas permeation and then loaded into the gas cell with the sampler holder immersed in the deionized water bath for temperature control. The entire system (upstream and downstream sides) was degassed in vacuo for at least 12 hours before introducing ultra-high purity grade gases that were maintained at 30, 50, and 80 psig until a steady state increase in pressure vs time in the downstream was achieved. The permeability for each gas was calculated using the expression below:

$$P = {10}^{10} \frac{{V}_{d} l}{{P}_{up} TRA} [ {( \frac{dp}{dt} )}_{ss} - {( \frac{dp}{dt} )}_{leak} ] ,$$

where P (Barrer, 1 Barrer=1×10⁻¹⁰ cm³ [STP] cm²/(cm³ s cmHg)) is the gas permeability, l is the film thickness (cm), V_{d} is the calibrated downstream volume (cm³), Pᵤₚ is the upstream pressure (cmHg), A is the effective film area (cm²), (dp/dt)ₛₛ and (dp/dt)ₗₑₐₖ are the steady-state pressure increment in downstream, and the leak rate of the system (cmHg/s), respectively; T is the test temperature (K), and R is the gas constant (0.278 cm³ cmHg/(cm³ (STP) K)). The ideal selectivity (α_{A/B}) for two different gases, A (more permeable) and B, is defined as the ratio of pure gas permeability of the two gases and is calculated as

$${α}_{A / B} = {P}_{A} / {P}_{B}$$

### Dihedral Angle Analysis

Gaussian 16 is used to study the conformational flexibility of P130093 and P432352 by calculating the energy change associated with the change in the dihedral angles of interest. The initial polymer structures consisting of two repeated units (each the polymerization point at both ends is replaced by a hydrogen atom) are first built in Gaussview with energy minimization. Then, a relaxed potential energy scan is conducted where the specific dihedral angle of interest is fixed in each scan, and other parts of the molecule are relaxed to calculate the total energy. The semi-empirical method (pm6) is adopted throughout the simulations.

### Experimental Measurement and Calculation of Diffusivity, Solubility, Density, Fractional Free Volume (FFV), and T_{g}

The averaged-diffusion coefficient, D (cm² s⁻¹), was determined using the lag-time method. The solubility coefficient, S (cm³ (STP)/cm³ atm), was obtained using the relationship, S=P/D. The T_{g} of the polymers is determined using the Differential Scanning calorimetry Q2000 by TA Instruments with 50 mL/min nitrogen purge at 10° C./min heating rate during the second heating cycle (100-400° C.). The polymer densities are obtained by the buoyancy technique, which relies on Archimedes' principle. Thin films of the polymers are weighed in air and in deionized water using an analytical balance ML 204 by Mettler Toledo fitted with density measurement kit at room temperature. The FFVs are computed using Bondi's group contribution method.

### MD Simulation Analysis of Polymer Free Volume Pores

The procedure of calculating void volume (Vv) and free volume pore size distribution (PSD) for the two polymers using MD simulations is composed of two steps: amorphous polymer structure generation and pore structure characterization. Details are shown below.

### Step 1: Amorphous Polymer Structure Generation

Taking the SMILES of the polymer as an input, the initial amorphous polymer structure is generated by a Python pipeline based on PYSIMM. It generates a polymer chain through polymerization, with the number of atoms per chain fixed to around 600. Then the chain is replicated, and a system of six chains in total is generated and enclosed in a simulation box. Meanwhile, the GAFF2 (General AMBER Force Field 2) forcefield parameters are assigned to the polymer system and an input script for MD simulation using the large-scale atomic-molecular massively parallel simulator (LAMMPS) is generated. Periodic boundary conditions in all spatial directions are applied. The system is then optimized gradually.

First, the system is simulated with electrostatic interactions turned off and Lennard-Jones interactions with a cutoff of 0.300 nm, aiming to eliminate close contact between atoms. An NVT ensemble is applied at 100 K for 2 ps, with a timestep of 0.1 fs, followed by the system heating up from 100 K to 2000 K in 2 ns. Then, an NPT ensemble is employed at 2000K and 0.1 atm for 50 ps, after which the pressure is increased from 0.1 to 500 atm in 2 ns with temperature fixed at 2000K. Then the obtained polymer system is directly compressed in all spatial directions so as to match the density measurement from our experiment. After the initialization, the electrostatic interactions are turned on and the PPPM (Particle-Particle-Particle-Mesh)-based Ewald sum method is used. The Lennard-Jones interactions cutoff is set as 1.200 nm. To achieve a reliable amorphous polymer structure, an NVT ensemble is further applied at 2000 K for 0.2 ns, with a timestep of 0.1 fs, before the system is quenched. The snapshots at 0.12, 0.14, 0.16, 0.18 and 0.2 ns of the last step are saved for later pore structure characterization.

### Step 2: Pore Structure Characterization

PoreBlazer was used to characterize the pore size and distribution, which is calculated based on the Hoshen-Kopelman cluster labeling algorithm. The diameter of the probe is set to 1.25 Å, which is tuned so that it gives a similar magnitude of Vv as the experimentally calculated FFV. The calculated Vv and PSD are averaged across the five different snapshots as described in Step 1.

### Gas Transport Properties Analysis

To further understand the high performance of the two polymers, their glass transition temperatures (T_{g}) were measured, and their FFV, diffusivities, and solubilities were calculated. As shown in Table 1, a high T_{g} of 300° C. (for P432352) and a non-detectable T_{g} (for P130093) imply the high rigidity of the polymer backbones, which is beneficial for sieving gases based on their sizes. Moreover, both polymers have moderate to slightly high FFV, which corroborates their high performance. Besides, P432352 has a slightly higher FFV of 16.0% than P130093 (14.5%), which explains why P432352 has higher gas permeabilities. The tested light gases such as O₂, N₂, and CH₄ displayed size-sieving characteristics for both polymers, evidenced by the direct proportion between their diffusivities corresponding to their kinetic diameters. Moreover, both polymers show strong adsorption selectivity for CO₂ with high solubilities, which is a typical observation for most polyimides.

TABLE 1

| | P130093 | P432352 |
|---|---|---|
| Density (g/cm³) | 1.3119 | 1.1652 |
| FFV | 14.5% | 16.0% |
| T_{g} (° C.) | Not detectable | 300 |
| Vᵥ | 15.6% | 17.7% |

To support the experimental results, MD simulations were used to study these two polymers and calculated their void volume fractions (Vv) and pore size distributions (PSD). As shown in Table 1, the Vv's from MD simulations show the same trend as the experimentally calculated FFVs, where P432352 possesses a slightly higher fraction of voids than P130093, resulting in higher gas permeabilities. The PSD plot of either polymer also supports this finding, where the PSD of P432352 is right-shifted relative to that of P130093, suggesting that P432352 generally has larger pores, which contribute to higher gas permeabilities but lower selectivities than P130093.

While this disclosure has described certain embodiments, it will be understood that the claims are not intended to be limited to these embodiments except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed embodiments. However, it will be obvious to one of ordinary skill in the art that systems and methods consistent with this disclosure may be practiced without these specific details. In other instances, well-known methods, procedures, components, and circuits have not been described in detail so as not to unnecessarily obscure various aspects of the present disclosure.

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various presently disclosed embodiments. It should be borne in mind, however, that these terms are to be interpreted as referencing physical manipulations and quantities and are merely convenient labels that should be interpreted further in view of terms commonly used in the art. Unless specifically stated otherwise, as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers, or other such information storage, transmission, or display devices as described herein or otherwise understood to one of ordinary skill in the art.

What is claimed is:

1. A membrane for gas separation, comprising at least one of:
a polyimide of the formula 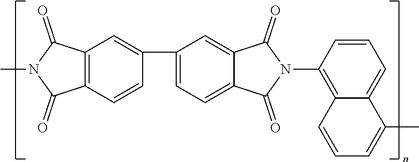
or a polyimide of the formula 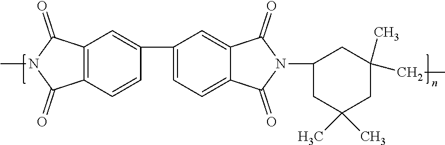
wherein the membrane is configured to separate at least one of H₂/N₂, H₂/CH₄, O₂/N₂, CO₂/N₂, or CO₂/CH₄.

2. The membrane of claim 1, wherein the polyimide is an aromatic polyimide.

3. The membrane of claim 1, wherein the aromatic polyimide is synthesized from a dianhydride and a diamine.

4. The membrane of claim 3, wherein the dianhydride is an aromatic dianhydride.

5. The membrane of claim 3, wherein the dianhydride is 3,3′,4,4′-biphenyltetracarboxylic dianhydride.

6. The membrane of claim 3, wherein the diamine is an aromatic diamine or aliphatic diamine.

7. The membrane of claim 3, wherein the diamine is naphthalene-1,5-diamine or isophorone diamine.

8. The membrane of claim 1, wherein the polyimide comprises poly[(naphthalene-1,5-diamine)-alt-(biphenyl-3,3′:4,4′-tetracarboxylic dianhydride)] or poly[isophoronediamine-alt-(biphenyl-3,3′,4,4′-tetracarboxylic anhydride)].

9. The membrane of claim 1, wherein the polyimide is synthesized by a polycondensation reaction.

10. The membrane of claim 1, wherein the polyimide formula is selected using performance data predicted by a machine learning model.

11. A composition comprising:
a polyimide of the formula: 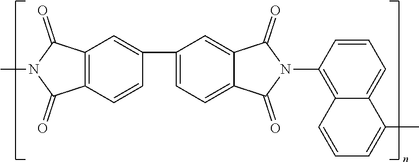
wherein the polyimide comprises a membrane configured to separate at least one of H₂/N₂, H₂/CH₄, O₂/N₂, CO₂/N₂, or CO₂/CH₄.

12. The composition of claim 11, wherein the aromatic polyimide is synthesized from a dianhydride and a diamine.

13. The composition of claim 12, wherein the dianhydride is an aromatic dianhydride.

14. The composition of claim 12, wherein the dianhydride is 3,3′,4,4′-biphenyltetracarboxylic dianhydride.

15. The composition of claim 12, wherein the diamine is naphthalene-1,5-diamine.

16. A composition comprising:
a polyimide of the formula: 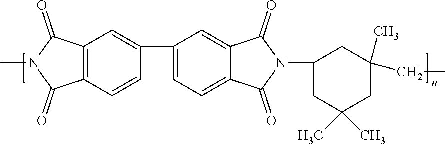
wherein the polyimide comprises a membrane configured to separate at least one of H₂/N₂, H₂/CH₄, O₂/N₂, CO₂/N₂, or CO₂/CH₄.

17. The composition of claim 16, wherein the partially aliphatic polyimide is synthesized from a dianhydride and a diamine.

18. The composition of claim 16, wherein the dianhydride is an aromatic dianhydride.

19. The composition of claim 16, wherein the dianhydride is 3,3′,4,4′-biphenyltetracarboxylic dianhydride.

20. The composition of claim 16, wherein the diamine is isophorone diamine.
